(19) United States
(12) Patent Application Publication
(10) Pub. No.: US 2011/0093886 A1
(43) Pub. Date: Apr. 21, 2011

(54) SUBSCRIBER-BASED ADVERTISING

(75) Inventors: K. M. Rajasekhar Reddy, Chennai (IN); Srinivas Wudali, Chennai (IN)

(73) Assignee: VERIZON PATENT AND LICENSING, INC., Basking Ridge, NJ (US)

(21) Appl. No.: 12/580,503

(22) Filed: Oct. 16, 2009

(51) Int. Cl. H04N 7/025; G06Q 30/00

(52) U.S. Cl. 725/34; 725/32; 705/14.69

(57) ABSTRACT

A method for enabling individual or small business advertisements on a television system may include receiving, at a service provider, advertisement information from a first subscriber. The advertisement information may be stored. Content displayed by a device associated with a second subscriber may be identified. It may be determined whether the content can receive advertisements. The stored advertisement information may be retrieved when it is determined that the content can receive advertisements. At least a portion of the retrieved advertisement information may be inserted into the content for viewing by the second subscriber.

### BACKGROUND

Advertising in large-scale media systems, such as national print media, television systems, or even the Internet typically requires a significant budget on the part of the advertising entity. This expense typically excludes individuals and small business from participating in large-scale advertising, thereby limiting these types of advertisers to local periodicals and online listings or auction-based services. Unfortunately, these types of advertising offerings require that potential consumers seek out or otherwise search for listed items.

### BRIEF DESCRIPTION OF THE DRAWINGS

FIG. 1 depicts a diagram of an exemplary network in which systems and methods described herein may be implemented;

FIG. 2 illustrates exemplary components of a device that may correspond to the television, set-top box (STB), service provider, and/or user device of the network depicted in FIG. 1;

FIG. 3 is an exemplary functional block diagram of components implemented in the user device of FIG. 1;

FIG. 4 illustrates an exemplary graphical user interface for receiving advertisement information by the advertisement receiving logic of FIG. 3;

FIG. 5 illustrates an exemplary graphical display for displaying an advertisement; and

FIG. 6 illustrates a flow chart of exemplary processes according to implementations described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Implementations described herein relate to devices, methods, and systems for facilitating the creation and distribution of advertisements between television system subscribers. In one exemplary implementation, a television system subscriber (hereinafter “subscriber”), such as an individual, a small business, etc., may wish to advertise, for example, a product, item, or service in a large-scale delivery platform with minimal effort or cost. As described in detail below, the television system subscriber may create and/or upload an advertisement or advertisement information relating to the item for sale, service offering, etc. The advertisement information may be uploaded to a service provider associated with the television system, such as, for example, via a web interface or logic included within a subscriber's set-top box (STB). The advertisement information may include descriptive text, images, video, audio, etc. During the advertisement creation process, a number of pricing plans may be presented to the subscriber for selection. Examples of pricing plans include a fixed cost for a predetermined number of served advertisement impressions. The term “impression” may be defined as a display or provisioning of an advertisement.

An advertisement engine associated with the service provider may store and index the advertisement based on information associated with the advertisement, such as type of product/service being advertised, the price of the advertisement product/service, the geographic location of the subscriber, etc. The advertisement engine may serve or otherwise distribute the advertisement to STBs associated with other subscribers. In some implementations, the advertisements served to subscribers may be targeted based on information, such as geographic location, the context of the current activity they are engaged in, subscriber demographics information, etc. In exemplary embodiments, the advertisements may be served and integrated into a service platform associated with the service provider, such as a STB graphical user interface. It should be understood that, as used herein, the terms “viewer,” “user,” and/or “subscriber” may be used interchangeably.

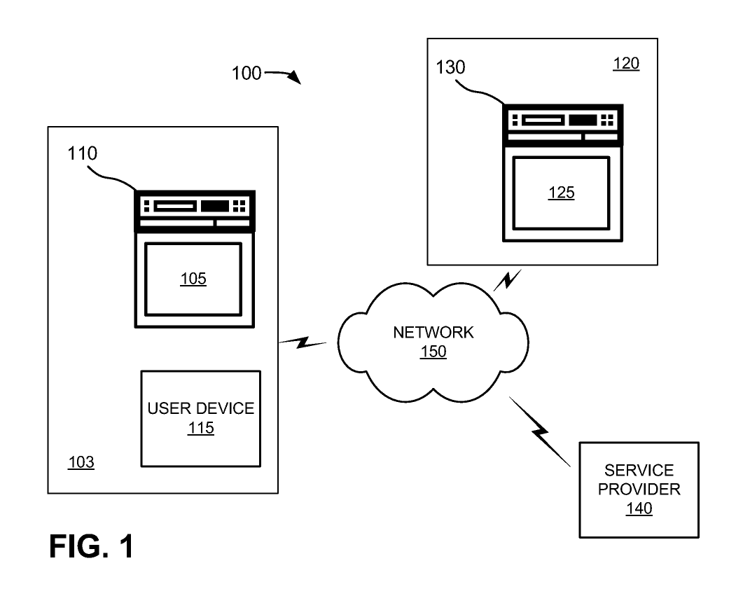

FIG. 1 is a diagram of an exemplary network 100 in which systems and methods described herein may be implemented. As illustrated, network 100 may include a first subscriber premises 103 that includes a television 105, a STB 110, and a user device 115, a second subscriber premises 120 that includes a television 125 and a STB 130, and a service provider 140 (e.g., one or more server devices) interconnected by a network 150. Components of network 100 may interconnect via wired, wireless, and/or optical connections. For simplicity, subscriber premises 103 and 120 have been depicted as including a single television (e.g., televisions 105 and 125), STB (e.g., STBs 110 and 130), and user device 115. Additionally, network 100 has been depicted in FIG. 1 as including a single service provider 140 and network 150. In practice, there may be more televisions 105/125, STBs 110/130, user devices 115, service providers 140, and/or networks 150. Also, in some instances, one or more of the components of network 100 may perform one or more functions described as being performed by another one or more of the components of network 100. For example, television 105 may include components and functionality typically associated with STB 110.

Televisions 105 and 125 may include any suitable display device capable of displaying television programming, content provided by STBs 110 and 130, respectively, and/or content provided by other devices (e.g., a digital video disk (DVD) player, a video camera, a home media player, etc., not shown) connected to televisions 105/125. Alternatively, televisions 105/125 may take the form of a personal digital assistant (PDA), a mobile phone, or any device with a display for viewing content.

STBs 110/130 may include a device that receives television programming (e.g., from service provider 140) and provides the television programming (e.g., live or recorded) to television 105/125 or another device. In some implementations, STBs 110/130 may include a digital video recorder (DVR) that records the received programming video for later viewing. STB 105/130 may allow a user to alter the programming provided to television 105/125 and/or scheduled for recording based on a signal from a remote control (not shown) via a number of suitable wireless communication technologies (e.g., radio frequency (RF), infrared (IR), Bluetooth®, or WiFi 802.11x). In one exemplary implementation, features of STBs 110/130 (e.g., processing logic, memory, a hard disk drive, scheduling components, etc.) may be incorporated directly within televisions 105/125.

Service provider 140 may include one or more server entities, or other types of computation or communication devices, that gather, process, search, and/or provide information in a manner described herein. In one implementation, service provider 140 may include a server (e.g., a computer system or an application), a cable head-end, or a broadcaster capable of providing content (e.g., TV programming, movies, on-demand services, live television, news feeds, blog feeds, advertisements, instructions, codes, encryption keys, and/or other information associated with products and/or services, etc.), to STBs 110 and 130. In some implementations, service provider 140 may be configured to receive information from and/or provide information to STBs 110 and 130 or user device 115 in the manner described below.

User device 115 may include a personal computer, a mobile or cellular telephone, a “smartphone” device (e.g., that may combine a cellular telephone with data processing and data communications capabilities), a personal digital assistant (PDA) (e.g., that can include a radiotelephone, a pager, Internet/intranet access, etc.), a laptop or notebook computer, an ultra mobile personal computer (UMPC), a netbook, or other types of computation or communication devices, threads or processes running on these devices, and/or objects executable by these devices. In one implementation, user device 115 may include any device (e.g., an Internet Protocol (IP)-based device) that is capable of accessing service provider 140 via network 150. In other implementations, user device 115 may be configured to interact with STB 110 or television 105, via a local network different than network 150 (e.g., a home wired or wireless network).

Network 150 may include a local area network (LAN), a wide area network (WAN), a metropolitan area network (MAN), a telephone network, such as the Public Switched Telephone Network (PSTN), an intranet, the Internet, an optical fiber (or fiber optic) network, or a combination of networks.

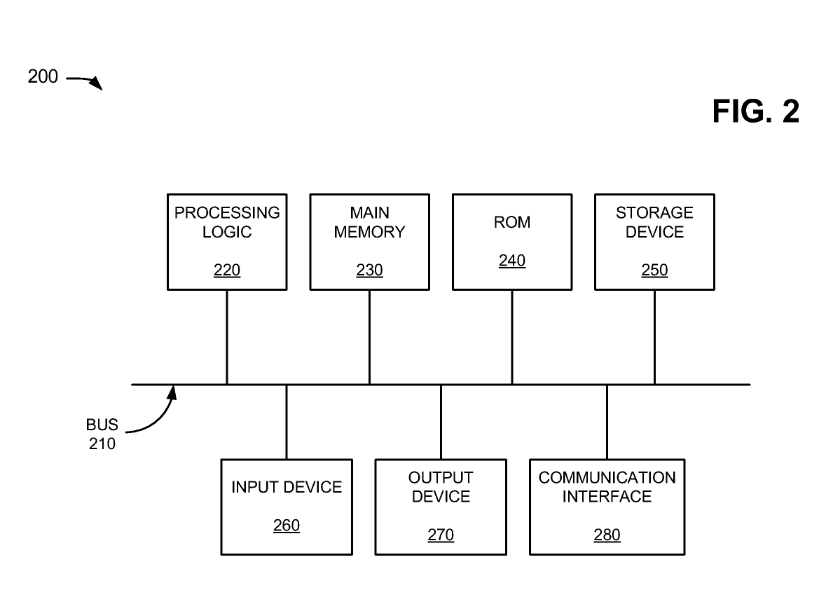

FIG. 2 is an exemplary diagram of a device 200 that may correspond to any of television 105/125, STB 110/130, service provider 140, and/or user device 115. As illustrated, device 200 may include a bus 210, processing logic 220, a main memory 230, a read-only memory (ROM) 240, a storage device 250, an input device 260, an output device 270, and/or a communication interface 280. Bus 210 may include a path that permits communication among the components of device 200.

Processing logic 220 may include a processor, microprocessor, or other type of processing logic that may interpret and execute instructions. Main memory 230 may include a random access memory (RAM) or another type of dynamic storage device that may store information and instructions for execution by processing logic 220. ROM 240 may include a ROM device or another type of static storage device that may store static information and/or instructions for use by processing logic 220. Storage device 250 may include a magnetic and/or optical recording medium and its corresponding drive. In one implementation storage device 250 may be configured to store television programming received by STBs 110 and 130 .

Input device 260 may include a mechanism that permits an operator to input information to device 200, such as a keyboard, a mouse, a pen, a microphone, voice recognition mechanisms, a remote control, etc. Output device 270 may include a mechanism that outputs information to the operator, including a display, a printer, a speaker, etc. Communication interface 280 may include any transceiver-like mechanism that enables device 200 to communicate with other devices and/or systems, such as subscriber premises 100/120, user device 115, etc. For example, communication interface 280 may include mechanisms for communicating with another device or system via a network, such as network 150.

As described herein, device 200 may perform certain operations in response to processing logic 220 executing software instructions contained in a computer-readable medium, such as main memory 230. A computer-readable medium may include a physical or logical memory device. The software instructions may be read into main memory 230 from another computer-readable medium, such as storage device 250, or from another device via communication interface 280. The software instructions contained in main memory 230 may cause processing logic 220 to perform processes described herein. Hardwired circuitry may be used in place of or in combination with software instructions to implement processes described herein. Thus, implementations described herein are not limited to any specific combination of hardware circuitry and software.

Although FIG. 2 shows exemplary components of device 200, in other implementations, device 200 may contain fewer, different, or additional components than depicted in FIG. 2. In still other implementations, one or more components of device 200 may perform one or more other tasks described as being performed by one or more other components of device 200.

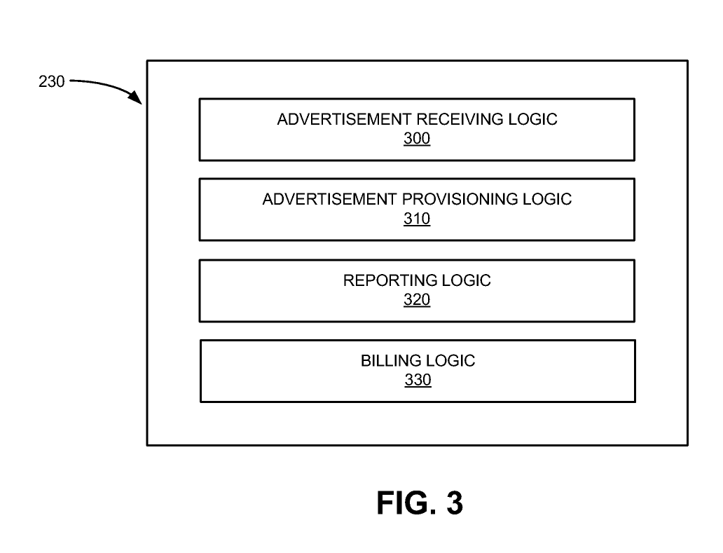

FIG. 3 is an exemplary functional block diagram of components associated with service provider 140 of FIG. 1. In an exemplary implementation, all or some of the components illustrated in FIG. 3 may be stored in memory 230. Furthermore, although depicted as a single entity 140 in FIG. 1 for the purposes of simplicity, in practice, service provider 140 may include more than one device, such as a number of distributed devices located at various geographic locations. Furthermore, functions described below as being performed by service provider 140 may be performed by different devices associated with service provider 140, such as a number of content servers, web servers, back end processing servers, etc.

Referring to FIG. 3, memory 230 may include advertisement receiving logic 300, advertisement provisioning logic 310, reporting logic 320, and billing logic 330. In addition, some or all of the logic components illustrated in FIG. 3 may be implemented by processing logic 220 executing one or more programs stored in memory 230.

Advertisement receiving logic 300 may include logic configured to receive, from a subscriber, information associated with an advertisement to be subsequently provided or served by advertisement provisioning logic 310. For example, advertisement receiving logic 300 may include a web server configured to provide a web page that includes a graphical user interface (GUI). A subscriber may interact with the web page/GUI to upload the advertisement information to service provider 140. Exemplary advertisement information may include a title for the advertisement listing, a description of the item/service being listed, an image, video, or audio file, etc. In addition to advertisement information, advertisement receiving logic 300 may also receive billing-related and provisioning-related information from the subscriber.

Exemplary billing-related information may include subscriber selections corresponding to a duration of the advertisement period, and a cost structure associated with the advertisement, such as a cost per impression or number of impressions (i.e., display of the advertisement to other subscribers), a cost per month, a cost per clickthrough, etc. Exemplary provisioning-related information may include a number of times that the advertisement will be displayed, advertisement provisioning criteria corresponding to the advertisement (e.g., type of content to advertise within, demographics associated with advertisement recipients (e.g., age, income, education, family-type, etc.).

Upon receipt of advertisement information, advertisement receiving logic 300 may stored the advertisement information into, for example a database or other data structure in storage device 250. In some implementations, advertisement receiving logic 300 may index or otherwise catalog the received advertisement information to facilitate subsequent searching and retrieval. In one exemplary embodiment, the database may be maintained on an advertisement server device associated with service provider 140.

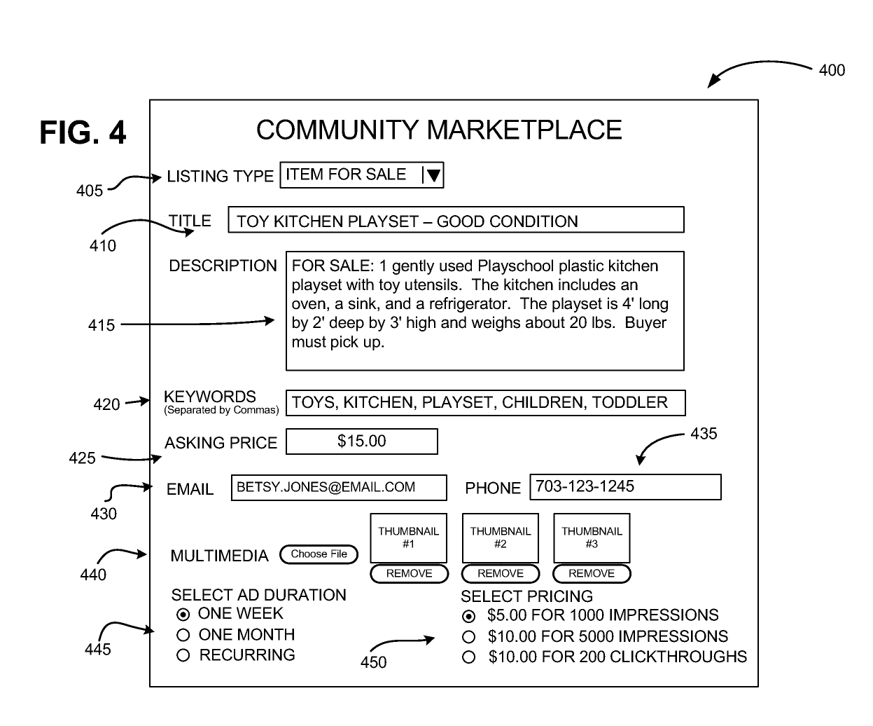

FIG. 4 is a diagram illustrating an exemplary GUI 400 provided by advertisement receiving logic 300. As shown in FIG. 4, GUI 400 may include a number of fields for receiving information associated with the subscriber advertisement. The exemplary fields in GUI 400 may include a listing type field 405, a title field 410, a description field 415, a keywords field 420, an asking price field 425, an email field 430, a phone field 435. GUI 400 may further include a multimedia section 440, an ad duration selection section 445, and pricing selection section 450. It should be understood that the components of GUI 400 illustrated in FIG. 4 are exemplary only. Any suitable combination of fields and or information entry components may be provided in a manner consistent with the description provided herein.

Listing type field 405 may receive a subscriber selection (e.g., in a drop down list or other selectable entry element) of an indication relating to the type of item or service being advertised. Exemplary listing types may include “item for sale,” “service provided,” “home/property for sale,” and “home/property for rent,” although any suitable listing type may be provided. Title field 410 may receive textual information corresponding to a title that the subscriber wishes to be displayed with the advertisement. Although the information provided in listing type field 410 may generally be descriptive in nature, other information may also be provided, such as attention getting phrases, pricing information, etc.

Description field 415 may receive textual information corresponding to a description of the item or service. In some implementations, description field 415 may be configured to receive stylized information, such as hypertext markup language (html), extensible markup language (xml), Flash, javascript, etc., to enable the subscriber to provide a visually interesting advertisement. Keywords field 420 may receive additional textual terms potentially useful in enabling service provider 140 to provide the advertisement to a relevant audience. Terms provided in keywords field 420 may or may not include terms otherwise appearing in title field 410, or description field 415.

Asking price field 425 may receive asking price information from the subscriber. The received information may be a discrete dollar amount or, in other implementations, may include a range of prices or a phrase such as “best offer.” In some implementations, asking price field 425 may request different types of information based on the selection made in listing type field 405. For example, a sales or rental listing type may request an asking price in asking price field 425, while a services-based listing may request price range or other relevant information in asking price field 425.

Email field 430 and phone field 435 may receive contact information associated with the subscriber submitting the advertisement. Multimedia section 440 may include components configured to receive one or more image, video, or audio files to be presented with the advertisement. In some implementations, upon selection of a multimedia file for uploading, the file may be uploaded and a thumbnail representing the file may be provided on GUI 400.

As described above, in addition to receiving advertisement-related information, GUI 400 may be configured to receive billing and provisioning related information. For example, ad duration selection section 445 may be configured to receive a subscriber selection of a duration in which the submitted advertisement will be provided. Exemplary durations include one week, one month, and recurring. Pricing selection section 450 may be configured to receive a subscriber selection of a pricing option. Exemplary pricing options include tiered pricing based on a number of provided impressions as well as additional pricing options relating to a number of clickthroughs (i.e., times that a viewer selected the ad for more information). For example, a subscriber may choose a lower amount for a number of impressions or a higher amount for a number of clickthroughs, with the expectation that achieving the selected number of clickthroughs may take an unknown number of impressions.

Although GUI 400 discloses a number of fields and types of information associated with an advertisement received from a subscriber, additional types of information may also be received and associated with the advertisement by advertisement receiving logic 300.

Returning to FIG. 3, advertising provisioning logic 310 may include logic configured to identify content being displayed on an STB (e.g., STB 130) in which an advertisement may be inserted (also referred to herein as “advertisable content”), identify an advertisement for placement within the advertisable content, and insert the advertisement into the advertisable content for transmission or delivery to the STB. For example, advertisement provisioning logic 310 may receive notifications or other information from STB 130 indicating the type of content being displayed via STB 130. Exemplary content may include an interactive media guide, live video programming, recorded video programming, on-demand video programming, pay-per-view programming, games, Internet content, social media content, widget-based content, sports-based content (such as fantasy sports content), music applications, photo viewing applications or content, etc..

Based on the type of content being displayed and, in some implementations, additional information relating to STB 130 (e.g., user/viewer information, etc.), advertisement provisioning logic 310 may identify and select one or more subscriber-uploaded advertisements for insertion into the content. For example, if advertisement provisioning logic 310 determines that STB 130 is displaying a cooking application or widget, advertisement provisioning logic 310 may identify home-improvement-related advertisements, such as an advertisement for handyman services, for insertion into the displayed content. In one implementation, advertisement provisioning logic 310 may identify the advertisement for insertion into the content by searching an index of advertisements created by advertisement receiving logic 300 and stored, e.g., in storage device 250. In addition to content type and STB information, advertisement provisioning logic 310 may further base advertisement identification on additional environmental factors, such as geographic location of STB, time of day, etc. Moreover, selection of an advertisement for provisioning may also be made based on the context of the currently displayed content. For example, if the viewer is watching content associated with automobiles, an advertisement for a used car may be identified for provisioning.

Advertisement provisioning logic 310 may retrieve the advertising information corresponding to the identified advertisement, e.g., from a database or other data structure, and insert the advertising information into the displayed content. In one implementation, the format of the displayed advertisement information may be established and controlled by the advertisement information received from the subscriber during upload, while in other implementations, the format of the displayed advertisement information may be established by advertisement provisioning logic 310, based on the content into which the advertisement information is inserted. For example, advertisement information inserted into a widget application may differ from identical advertisement information inserted into an interactive programming guide.

In some implementations, advertisement provisioning logic 310 may support the display of the advertisement information in a multi-tiered manner. For example, an initial advertisement listing may be initially inserted into the displayed content. Upon selection (e.g., “clicking”) of the initial advertisement listing, e.g., by a remote control or other input device 260, advertisement provisioning logic 310 may receive a request from STB 130 for additional advertisement information. In response, advertisement provisioning logic 310 may transmit the requested additional advertising information to STB 130 for display to the user. Exemplary additional advertisement information may include a full description of the goods/services being advertised, media associated with the advertisement, and contact information for the seller. In another implementation, advertisement provisioning logic 310 may transmit all available advertisement information to STB 130 upon initial provisioning and STB 130 may be configured to display the advertisement information in the above-described multi-tiered manner.

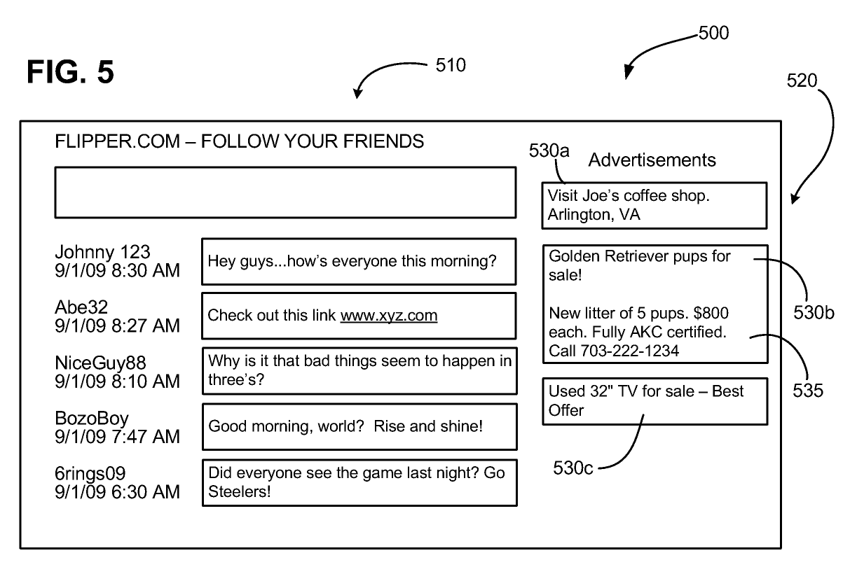

FIG. 5 is a diagram illustrating an exemplary graphical display 500 output by STB 130, e.g., to television 125. As shown in FIG. 5, display 500 may include a content area 510, and an advertisement area 520. Content area 510 may include graphical content selected by the viewer, such as an application, a game, a widget, video programming, etc. In this example, content area 510 includes a social networking application that displays a chronological listing of friends' comments. Advertisement area 520 may be provided adjacent content area 510 and may display advertisement listings 530a, 530b, and 530c (collectively referred to as “advertisement listings 530” or individually as “advertisement listing 530”) that include advertisement information inserted by advertisement provisioning logic 310. As illustrated in FIG. 5, advertisement area 520 may simultaneously include a number of advertisement listings 530. Although content area 510 and advertising area 520 in FIG. 5 are depicted as being graphically independent, in other implementations, advertising area 520 may overlap or otherwise overlay portions of content area 510.

Given the interactive nature STB 130, users may navigate around graphical display 500 by using, e.g., a remote control or other input device. In this manner, users may select an advertisement listing 530 for viewing more information. In the example of FIG. 5, advertisement listing 530b has been selected for viewing more information, with additional information 535 associated with advertisement listing 530b being displayed in graphical display 500. Additional information 535 may be displayed in a number of ways, such as by a dedicated graphical display or via a modified advertisement area 520. In the example of FIG. 5, the additional information 535 is overlaid in advertising area 520, while leaving content area unobscured. This technique enables the user to examine an advertisement listing 530 without navigating away from their initially viewed content.

Returning to FIG. 3, reporting logic 320 may include logic configured to compile or collect, e.g., from advertisement provisioning logic 310 and/or displaying STBs 130, information regarding the uploaded advertisements. For example, reporting logic 320 may monitor and log each time that an advertisement is displayed by an STB. Additionally, reporting logic 320 may monitor and log clickthroughs associated with each advertisement. Logged information may include a description of the advertisement along with a time and date corresponding to each impression. In other implementations, additional details regarding the impressions may be compiled, such as the type of content in which the advertisement was displayed, etc.

Reporting logic 320 may generate a report based on the collected information. In one implementation, the report may be generated for each advertisement on a monthly basis and may form the basis for subscriber advertisement billing, by billing logic 330. Additionally, service provider 140 may store the report for subsequent retrieval and display to the associated subscriber. Additionally, the report may be incorporated into a monthly billing statement associated with the subscriber's account.

Billing logic 330 may include logic configured to charge the subscriber for the advertisement based on the pricing plan selected during advertisement creation, or otherwise associated with the advertisement. Additionally, as described above, billing logic 330 may use the reports generated by reporting logic 320 to bill the subscriber. For example, reporting logic 320 may generate a report that indicates that an advertisement was displayed 150 times during the current billing cycle and was “clicked on” 8 times. Depending on the selected billing or price play, billing logic 330 may determine the appropriate charge. For example, if the user selected a price plan of $0.20 per click, the user would be charged $1.60 (e.g., $0.20 times 8 clicks) for the advertisement for the current billing cycle. However, if the user selected a price plan of $0.02 per impression, the user would be charged $3.00 (e.g., 150 impressions times $0.02) for the advertisement for the current billing cycle. Once the billing charge is determined, billing logic 330 may generate a corresponding charge in the subscriber's account and further generate a billing statement detailing the current charges. As mentioned above, the generated billing statement may include the report generated by reporting logic 320. Furthermore, although not referenced above, it should be understood that billing logic 330 may be further configured to handle subscriber billing for any additional services provided during the billing cycle, such as programming charges, STB rental charges, pay-per-view charges, etc.

As mentioned above, in some implementations advertising subscribers may also have the option of selecting a fixed price for a set number of impressions and/or clickthroughs. Although in this embodiment, the billing amount for these types of pricing selections would be preset, billing logic 330 may be configured to provide the generated report in the subscriber's billing statement for review. In some implementations, the generated report may be made available to the user via a web interface associated with service provider 140.

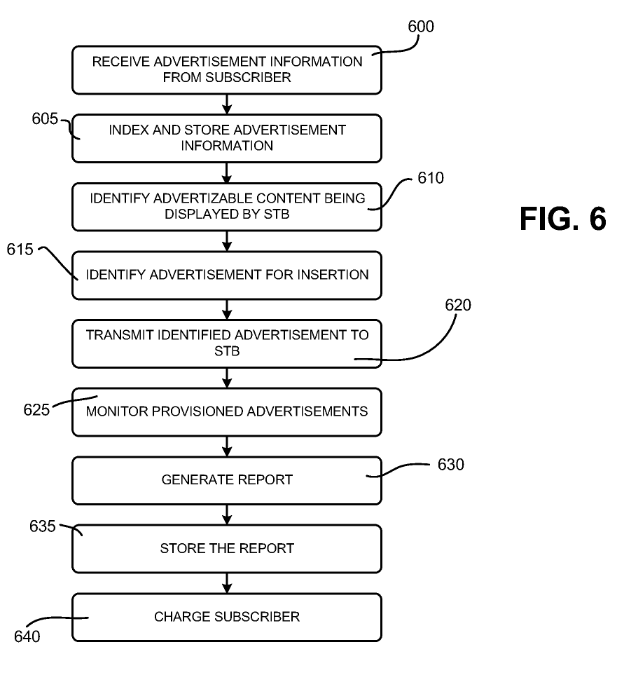

FIG. 6 is a flow diagram illustrating exemplary processing associated with the creating and providing subscriber-based advertisements consistent with embodiments described above. Processing may begin with advertisement receiving logic 300 receiving advertisement information from a subscriber (block 600). As described above, in one implementation, advertisement receiving logic 300 may include a web server or other interface for receiving the advertisement information from the subscriber, e.g., via user device 115 and/or STB 110. The received advertisement information may include title, description, and media relating to the advertisement item, as well as subscriber contact information and pricing selection information.

Advertisement receiving logic 300 may index and store the index and the received advertisement information for subsequent retrieval by advertisement provisioning logic 310 (block 605). For example, advertisement receiving logic 300 may store the index and the received advertisement information in a database or other structure (e.g., an advertisement server device) associated with service provider 140.

Advertisement provisioning logic 310 may identify advertisable content being displayed at a subscriber premises, such as subscriber premises 120 (block 610). For example, as described above, advertising provisioning logic 310, may receive an indication from STB 130 relating to content being displayed via STB 130. Alternatively, advertising provisioning logic 310 may periodically query STB 130 to determine content being displayed thereby. Upon receipt of content identification relating to STB 130, advertising provisioning logic 310 may determine whether the identified content is advertisable content. That is, whether the content can receive subscriber-based advertisements therein.

When it is determined that STB 130 is displaying or providing advertisable content, advertisement provisioning logic 310 may identify a subscriber-based advertisement for insertion into the content (block 615). For example, advertising provisioning logic 310 may search the stored index for advertisement information for insertion into the content. In some implementations, the index may be searched based on the identified advertisable content, information associated with the customer premises, such as demographic information, viewer profile information, time/date information, etc.

Advertisement provisioning logic 310 may transmit at least a portion of the advertisement information associated with the identified advertisement to STB 130 for insertion into the advertisable content (block 620). For example, advertising provisioning logic 310 may retrieve advertisement information associated with the identified advertisement from the database or advertisement server. In some implementations, some or all of the retrieved advertisement information may be transmitted to STB 130 for insertion into the advertisable content, while in other implementations, advertisement provisioning logic 310 may insert the advertisement information into the advertisable content at service provider 140 prior to transmission of the advertisable content to STB 130.

Reporting logic 320 may monitor advertisements provisioned by advertisement provisioning logic 310 (block 625). For example, reporting logic 320 may monitor and log each time that an advertisement is displayed by an STB (i.e., each impression). Additionally, reporting logic 320 may monitor and log clickthroughs associated with each advertisement. The logged information may, in some implementations, include a description of the advertisement along with a time and date corresponding to each impression and/or clickthrough.

Reporting logic 320 may generate a report, e.g., a monthly or billing-cycle report, based on the collected information (block 630). Reporting logic 320 may store the report for subsequent retrieval and display to the associated subscriber (block 635). For example, the report may be incorporated into account or billing information associated with the subscriber that uploaded the advertisement.

Billing logic 330 may charge the subscriber for the uploaded advertisements based on the pricing plan selected during advertisement creation, or otherwise associated with the advertisement (block 640). Additionally, as described above, billing logic 330 may also use the reports generated by reporting logic 320 to bill the subscriber. Depending on the selected billing or price plan, billing logic 330 may determine the appropriate charge. Once the billing charge is determined, billing logic 330 may generate a corresponding charge in the subscriber's account.

The above described systems and methods provide mechanisms for receiving advertisement information from television system subscribers for dissemination to and viewing by other television system subscribers. The simple advertisement creation process and efficient distribution method described above enable individuals or small businesses to effectively advertise on a large-scale television system without the traditional expense required.

The foregoing description of exemplary implementations provides illustration and description, but is not intended to be exhaustive or to limit the embodiments described herein to the precise form disclosed. Modifications and variations are possible in light of the above teachings or may be acquired from practice of the embodiments.

For example, various features have been mainly described above with respect to a service provider devices performing advertisement receiving and provisioning functions. In other implementations, features described herein may be implemented by devices or systems separate from the service provider, such as a third party advertising entity.

Further, while series of blocks have been described with respect to FIG. 6, the order of the acts may be varied in other implementations. Moreover, non-dependent acts may be implemented in parallel.

It will also be apparent that various features described above may be implemented in many different forms of software, firmware, and hardware in the implementations illustrated in the figures. The actual software code or specialized control hardware used to implement the various features is not limited. Thus, the operation and behavior of the features of the invention were described without reference to the specific software code—it being understood that one would be able to design software and control hardware to implement the various features based on the description herein.

Further, certain features described above may be implemented as “logic” that performs one or more functions. This logic may include hardware, such as one or more processors, microprocessors, application specific integrated circuits, or field programmable gate arrays, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A method, comprising:
receiving, at a service provider, advertisement information from a first subscriber;
storing the advertisement information;
identifying content displayed by a device associated with a second subscriber;
determining whether the content can receive advertisements;
when it is determined that the content can receive advertisements, retrieving the stored advertisement information; and
inserting at least a portion of the retrieved advertisement information into the content for viewing by the second subscriber.

2. The method of claim 1, wherein the advertisement information includes at least a description of the item and/or service being advertised or contact information associated with the first subscriber.

3. The method of claim 1, wherein the first subscriber is associated with a small business.

4. The method of claim 1, further comprising:
receiving price selection information from the first subscriber; and
charging the first subscriber based on the received price selection information.

5. The method of claim 4, wherein the price selection information includes a cost per impression, a cost per clickthrough, a cost per set of impressions, or a cost per set of clickthroughs.

6. The method of claim 1, wherein the storing the advertisement information comprises indexing the advertisement information.

7. The method of claim 1, further comprising:
receiving advertisement information for a number of advertisements from a number of first subscribers;
identifying one of the number of advertisements when it is determined that the content can receive advertisements;
retrieving the stored advertisement information associated with the identified one of the number of advertisements; and
inserting the retrieved advertisement information into the content.

8. The method of claim 7, wherein the identifying one of the number of advertisements is based on the content being displayed, requirements included in the advertisement information, or information associated with the second subscriber.

9. The method of claim 8, wherein the information associated with the second subscriber includes demographic information or viewer profile information.

10. The method of claim 8, wherein identifying one of the number of advertisements based on the content being displayed comprises identifying one of the number of advertisements based on a type of content being displayed.

11. The method of claim 8, wherein identifying one of the number of advertisements based on the content being displayed comprises identifying one of the number of advertisements based on a context associated with the content being displayed.

12. The method of claim 1, wherein inserting at least a portion of the retrieved advertisement information into the content comprises transmitting the retrieved advertisement information to a set-top box (STB) associated with the second subscriber.

13. The method of claim 1, further comprising:
monitoring a number of times that the advertisement information has been displayed during a period of time; and
generating a report associated with the advertisement information, wherein the report includes at least the number of times that the advertisement has been displayed during the period of time.

14. The method of claim 1, further comprising:
charging an account associated with the first subscriber upon insertion of the advertisement information into the content.

15. The method of claim 1, further comprising:
monitoring a number of times that the advertisement information has been displayed during a period of time;
generating a report associated with the advertisement information, wherein the report includes at least the number of times that the advertisement has been displayed during the period of time; and
charging an account associated with the first subscriber based on the report.

16. A device, comprising:
a communication interface;
a memory; and
logic configured to:
receive advertisement information from a first subscriber via the communication interface;
store the advertisement information in the memory;
receive, via the communication interface, an indication from a device associated with a second subscriber regarding content being displayed by the device;
determine whether the content being displayed is advertisable content;
retrieve the stored advertisement information from the memory when it is determined that the content is advertisable content;
insert at least a portion of the retrieved advertisement information into the content; and
transmit the content to the device via the communication interface.

17. The device of claim 16, wherein logic is further configured to:
receive advertisement information relating to a number of advertisements from a number of subscribers via the communication interface;
select one of the number of advertisements;
retrieve the stored advertisement information for the selected one of the number of advertisements from the memory;
insert the retrieved advertisement information into the content; and
transmit the content to the device via the communication interface.

18. The device of claim 17, wherein the one of the number of advertisements is selected based on a viewer profile associated with the second subscriber.

19. The device of claim 16, wherein the logic is further configured to charge an account associated with the first subscriber when the advertisement information is transmitted to the device associated with the second subscriber.

20. The device of claim 19, wherein the logic is further configured to:
receive price selection information from the first subscriber via the communication interface, wherein the price selection information indicates cost per impression or a cost per clickthrough associated with the advertisement information; and
charge the account associated with the first subscriber based on the price selection information.

21. The device of claim 19, wherein the logic is further configured to:
log a number of impressions or clickthroughs of the advertisement information over a period of time; and
charge the account associated with the first subscriber based on the logged number of impressions or clickthroughs.

22. The device of claim 16, wherein the advertisement information is received via a web interface associated with the communication interface.

23. A computer-readable medium having stored thereon sequences of instructions which, when executed by at least one processor, cause the at least one processor to:
receive advertisement information from a first subscriber via a web interface, wherein the advertisement information includes advertisement description information and pricing information;
store the advertisement information;
receive an indication from a device associated with a second subscriber regarding content being displayed by the device;
retrieve the stored advertisement information from the memory;
insert at least a portion of the retrieved advertisement information into the content;
transmit the content to the device; and
charge an account associated with the first subscriber based on the received pricing information when the advertisement information is transmitted to the device associated with the second subscriber.
